(19) United States
(12) Patent Application Publication
(10) Pub. No.: US 2026/0220301 A1
(43) Pub. Date: Jul. 30, 2026

(54) DE-IDENTIFIED AND SIMILARITY-PRESERVED BIG DATA COLLECTION USING AI

(71) Applicant: Media Tek Singapore Pte. Ltd., Singapore (SG)

(72) Inventors: Hung-Yueh Chen, Seongnam-si (KR); Byeng Hyun Kim, Seongnam-si (KR); Jung Shup Shin, Seongnam-si (KR); Yu-Lun Chang, Hsinchu (TW); Yi-Chan Tsai, Hsinchu (TW); Pei-Tsung Wu, Hsinchu (TW); Wei-Hao Pan, Hsinchu (TW); Chanuk Ju, Seongnam-si (KR); Hyunsuk Jang, Seongnam-si (KR); Jinwook Jeon, Seongnam-si (KR); Sangho Park, Seongnam-si (KR); Seohee Hong, Seongnam-si (KR)

(21) Appl. No.: 19/036,255

(22) Filed: Jan. 24, 2025

(51) Int. Cl. G06F 21/62

(52) U.S. Cl. CPC G06F 21/6254

(57) ABSTRACT

In an aspect of the disclosure, a method, a computer-readable medium, and an apparatus are provided. The method includes a method of operations of a computing device. The computing device receives input text. The computing device identifies sensitive information within the input text. The computing device converts the identified sensitive information into semantically meaningful text. The computing device appends supporting information to the semantically meaningful text to generate modified text. The computing device generates, using an artificial intelligence embedding model, a vector representation of the modified text. The computing device replaces the sensitive information with the vector representation.

### BACKGROUND

### Field

The present disclosure relates generally to data processing, and more particularly, to techniques of de-identified and similarity-preserved big data collection.

### Background

The statements in this section merely provide background information related to the present disclosure and may not constitute prior art.

In recent years, the proliferation of connected devices and digital services has led to an unprecedented generation of user data. This data has become increasingly valuable for developing artificial intelligence (AI) models, improving services, and conducting market analysis. Traditional data collection methods typically gathered raw information directly from user devices, including personal identifiers, location data, usage patterns, and other sensitive information. However, this practice has raised significant privacy concerns and legal challenges, particularly with the implementation of strict data protection regulations worldwide.

Prior approaches to protecting user privacy while collecting data often relied on basic anonymization techniques, such as removing obvious identifiers or replacing them with pseudonyms. These methods, however, proved insufficient as advanced data analysis techniques could often re-identify individuals through pattern matching and correlation of multiple data points. Some organizations attempted to address this by implementing data masking or encryption, but these solutions often rendered the data less useful for AI model training and pattern analysis, as they destroyed the semantic relationships between different data points.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method includes a method of operations of a computing device. The computing device receives input text. The computing device identifies sensitive information within the input text. The computing device converts the identified sensitive information into semantically meaningful text. The computing device appends supporting information to the semantically meaningful text to generate modified text. The computing device generates, using an artificial intelligence embedding model, a vector representation of the modified text. The computing device replaces the sensitive information with the vector representation.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of sensitive information.

FIG. 2(A) is a diagram illustrating an example regarding text similarity comparison.

FIG. 2(B) is a diagram illustrating an example of a text model.

FIG. 3 is a simplified block diagram of a computing device.

FIG. 4 is a simplified block diagram of a distributed computing system.

FIG. 5 is a flow chart illustrating a process for applying embedding.

FIG. 6(A) is a diagram showing an example of original text.

FIG. 6(B) is a diagram showing an example of sensitive information identification.

FIG. 6(C) is a diagram showing an example of information conversion.

FIG. 6(D) is a diagram showing an example of supporting information appending.

FIG. 6(E) is a diagram showing an example of random data appending.

FIG. 6(F) is a diagram showing an example of applying embedding.

FIG. 6(G) is a diagram showing another example of applying embedding.

FIG. 7 is a diagram illustrating an example of a test result.

FIG. 8 illustrates a flow chart of a process for converting text into a vector.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

The present disclosure relates to de-identified and similarity-preserved big data collection using artificial intelligence (AI). The disclosure addresses challenges in collecting big data from users of various devices, including mobile phones, tablets, personal computers (PCs), wearable devices, and various services such as games, online shops, online services, and applications (APPs). The disclosure particularly focuses on market users who employ terminal devices with connectivity capabilities, such as mobile devices. While the collected data serves as a valuable resource for developing AI models and conducting data analysis, legal concerns arise when device manufacturers collect sensitive information, such as location data, account identifiers, and other personal details.

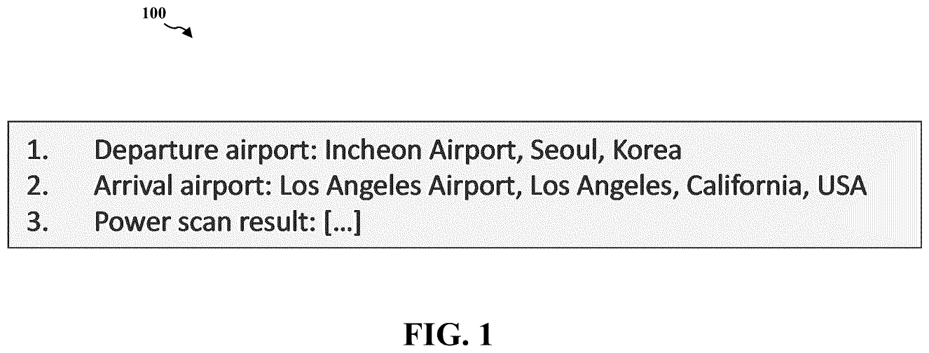

FIG. 1 is a diagram 100 that illustrates an example scenario involving sensitive information collection. In this scenario, a mobile feature requires knowledge of a user's location, particularly when the user is at an airport. The desired information includes location data and mobile device details, such as power scan results. However, device manufacturers have previously requested chip vendors to remove confidential or sensitive information to avoid legal issues, resulting in significant information loss that could have been valuable for analysis and development.

The present disclosure introduces an AI embedding model approach to collect information for AI model development and data analysis while maintaining compliance with legal requirements. The AI embedding model enables big data collection from users without encountering legal issues by converting text into vectors—numerical representations that preserve semantic relationships while obscuring the original sensitive information. These vectors support similarity comparisons between different pieces of information while making it difficult to reconstruct the original sensitive data.

The embedding model may be implemented as a standalone text-to-vector conversion mechanism independent of any large language models or similar systems. It does not require integration with an LLM and can function on its own to convert textual input into numerical vectors that capture semantic relationships. As a self-contained module, the embedding model focuses on providing robust text-to-data conversion, supporting similarity comparisons between embeddings, and resisting direct reconstruction of the original text from the generated vectors. This conversion algorithm can be incorporated into various computing environments as a computer-executable component, fully operational without reliance on large language models or related external frameworks.

The embedding model operates independently with three primary characteristics: text-to-data conversion capability, support for similarity comparisons, and resistance to reverse engineering of the converted data. This conversion algorithm can be implemented through various techniques such as word embeddings, sentence embeddings, or other vector space models that capture semantic relationships between texts. The model can be trained specifically for the embedding task without relying on broader language modeling capabilities.

The disclosure addresses several key challenges in big data collection. First, it provides methods for de-identifying sensitive information while maintaining the utility of the data for AI model development. Second, it preserves similarity relationships between different pieces of information, enabling meaningful analysis and pattern recognition. Third, it creates a framework for collecting valuable user data while respecting privacy concerns and legal requirements.

The implementation includes mechanisms for converting various types of sensitive information into more general or abstracted forms. For example, specific location coordinates may be converted into general area descriptions, user identifiers may be mapped to demographic categories, and temporal patterns may be transformed into behavioral indicators, all while maintaining the semantic relationships necessary for meaningful analysis.

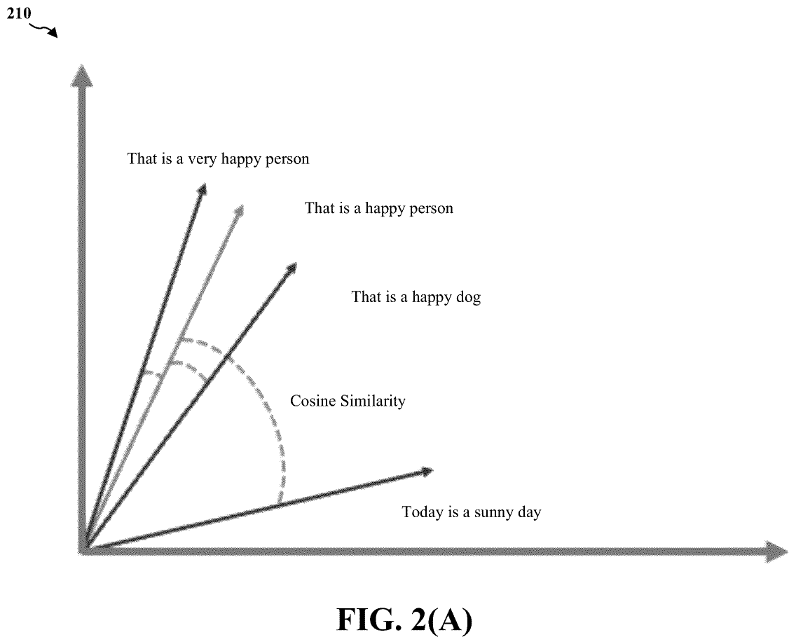

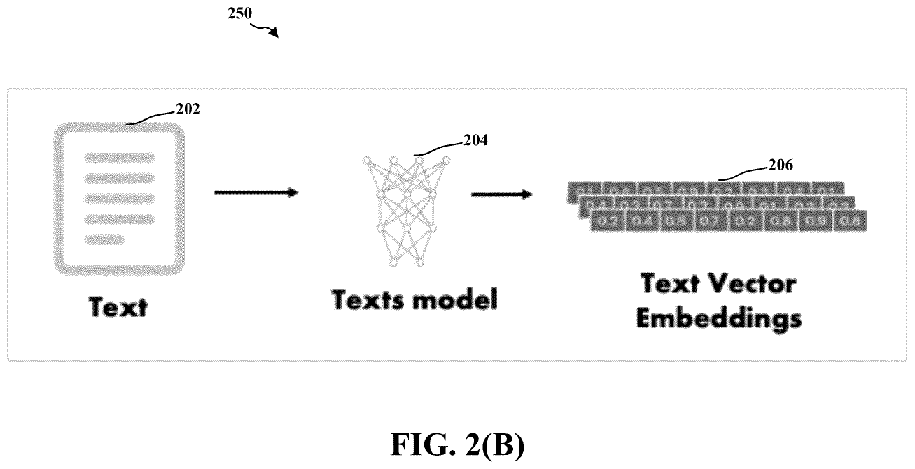

FIG. 2(A) is a diagram 210 that demonstrates the principles of text similarity comparison using vector embeddings. The diagram illustrates four example sentences positioned as vectors in a conceptual space, where their relative positions and angles represent their semantic relationships. The sentences “That is a very happy person”, “That is a happy person”, “That is a happy dog”, and “Today is a sunny day” are arranged such that their angular distances correspond to their semantic similarities.

The diagram 210 employs cosine similarity, a mathematical measure that quantifies the similarity between two non-zero vectors by computing the cosine of the angle between them. The cosine similarity values range from −1 to 1, where 1 indicates perfect similarity, 0 indicates orthogonality (no similarity), and −1 indicates opposite meanings. In the illustrated example, the vectors representing semantically similar sentences, such as “That is a very happy person” and “That is a happy person”, exhibit smaller angular distances and thus higher cosine similarity values. Conversely, the vector for “Today is a sunny day” shows a larger angular separation, indicating lower semantic similarity with the other sentences.

FIG. 2(B) is a diagram 250 that illustrates the text embedding process through three main components. The first component is the input text 202, represented as a document or string. This text passes through a texts model 204, which is an AI embedding model that processes and transforms the input text. The texts model 204 applies natural language processing techniques to convert the textual input into a mathematical representation. The final component is the text vector embeddings 206, which are numerical arrays representing the semantic content of the input text in a high-dimensional space.

The text vector embeddings 206 capture various semantic aspects of the input text, including contextual relationships, word meanings, and syntactic structures. These embeddings are represented as sequences of numbers, typically floating-point values between 0 and 1, as shown in the diagram. The resulting vectors enable quantitative comparisons between different texts while making it computationally intensive to reconstruct the original text from the embeddings alone.

The AI embedding model serves as a transformation function that maps text to a vector space while preserving semantic relationships. This transformation provides two key advantages: it enables similarity-based analysis through vector comparisons, and it creates a form of data protection by making reverse engineering from vectors to original text computationally challenging. The model can process various text units, from individual words to complete sentences or documents, offering flexibility in the granularity of the embedding process.

The vector transformation process maintains semantic relationships while introducing sufficient complexity to prevent straightforward reconstruction of the original text. This characteristic is particularly valuable for applications requiring privacy preservation while maintaining the utility of the data for analysis and machine learning purposes. When combined with additional techniques such as random data augmentation, the embedding process provides a robust method for protecting sensitive information while preserving the ability to perform meaningful similarity analyses.

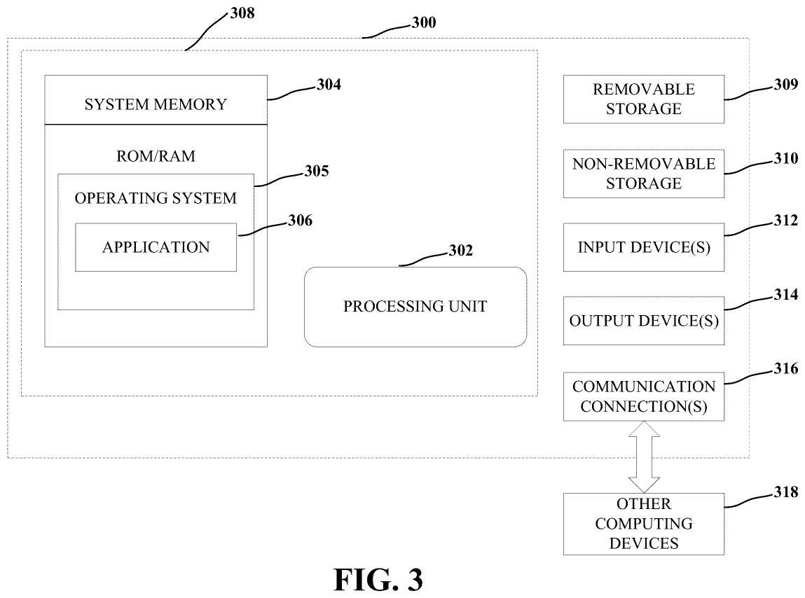

FIG. 3 is a block diagram illustrating example physical components of a computing device for executing the AI embedding model. In a basic configuration, a computing device 300 may include at least one processing unit 302 and a system memory 304. Depending on the configuration and type of computing device, system memory 304 may include, but is not limited to, volatile (e.g. RAM), non-volatile (e.g. ROM), flash memory, or any combination. System memory 304 may include an operating system 305 and application 306. Operating system 305, for example, may be suitable for controlling the computing device 300's operation. The application 306 (which, in some embodiments, may be included in the operating system 305) may include functionality for performing routines including, for example, customizing language modeling components for accomplishing the AI embedding model.

The computing device 300 may have additional features or functionality. For example, the computing device 300 may also include additional data storage devices (removable and/or non-removable) such as, for example, magnetic disks, optical disks, solid state storage devices (“SSD”), flash memory or tape. Such additional storage may include a removable storage 309 and a non-removable storage device 310. The computing device 300 may also have input device(s) 312 such as a keyboard, a mouse, a pen, a sound input device (e.g., a microphone), a touch input device for receiving gestures, an accelerometer or rotational sensor, etc. Output device(s) 314 such as a display, speakers, a printer, etc. may also be included. The aforementioned devices are examples and others may be used. The computing device 300 may include one or more communication connections 316 allowing communications with other computing devices 318. Examples of suitable communication connections 316 include, but are not limited to, RF transmitter, receiver, and/or transceiver circuitry; universal serial bus (USB), parallel, and/or serial ports.

Furthermore, various embodiments may be practiced in an electrical circuit including discrete electronic elements, packaged or integrated electronic chips containing logic gates, a circuit utilizing a microprocessor, or on a single chip containing electronic elements or microprocessors. For example, various embodiments may be practiced via a SOC where each or many of the components illustrated in FIG. 3 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may operate via application-specific logic integrated with other components of the computing device/system 300 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

The term computer readable media as used herein may include computer storage media. Computer storage media may include volatile and nonvolatile, removable and non-removable media implemented in any method or technology for storage of information, such as computer readable instructions, data structures, or program modules. The system memory 304, the removable storage device 309, and the non-removable storage device 310 are all computer storage media examples (i.e., memory storage.) Computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 300. Any such computer storage media may be part of the computing device 300. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

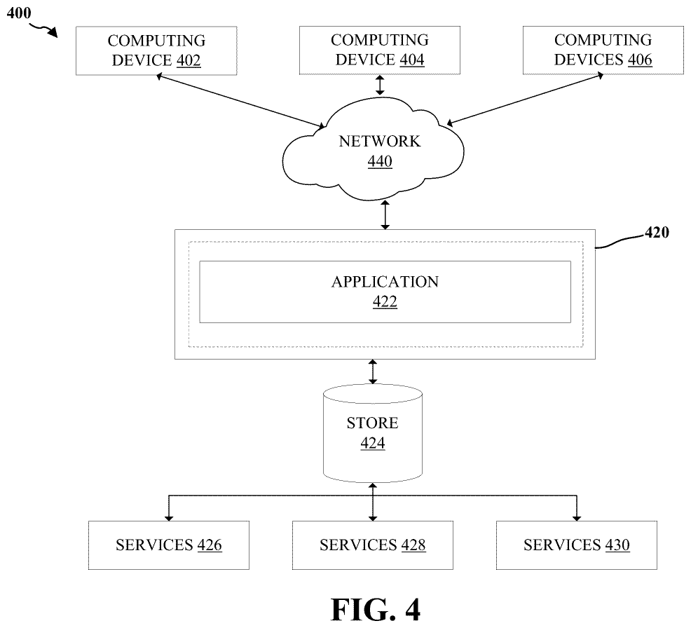

FIG. 4 is a simplified block diagram 400 of a distributed computing system for application of the AI embedding model. The distributed computing system may include number of client devices such as computing devices 402, 404 and 406. The computing devices may include a tablet computing device or a mobile computing device. The client devices 402, 404 and 406 may be in communication with a distributed computing network 440 (e.g., the Internet). A server 420 is in communication with the client devices 402, 404 and 406 over the network 440. The server 420 may store application 422 which may be perform routines including, for example, customizing language modeling components, such as a LLM.

Content developed, interacted with, or edited in association with the application 422 may be stored in different communication channels or other storage types. For example, various documents may be stored using various services 426, 428 and 430. The services may include a directory service, a web portal, a mailbox service, an instant messaging store, or a social networking site. The application 422 may use any of these types of systems or the like for enabling data utilization such data analysis, as described herein. As one example, the server 420 may be a web server providing the application 422 over the web. The server 420 may provide the application 422 over the web to clients through the network 440. By way of example, the computing devices 402, 404 and 406 may be embodied in a personal computer, a tablet computing device and/or a mobile computing device (e.g., a smart phone). Any of these embodiments of the computing devices 402, 404 and 406 may obtain content from the store 424.

The server 420 may be embodied in a base station. The base station may be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station provides an access point to a core network for a computing device such as a user equipment (UE). Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UE may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The present disclosure may reference 5G New Radio (NR). The present disclosure may also be applicable to other similar areas, such as LTE, LTE-Advanced (LTE-A), Code Division Multiple Access (CDMA), Global System for Mobile communications (GSM), or other wireless/radio access technologies.

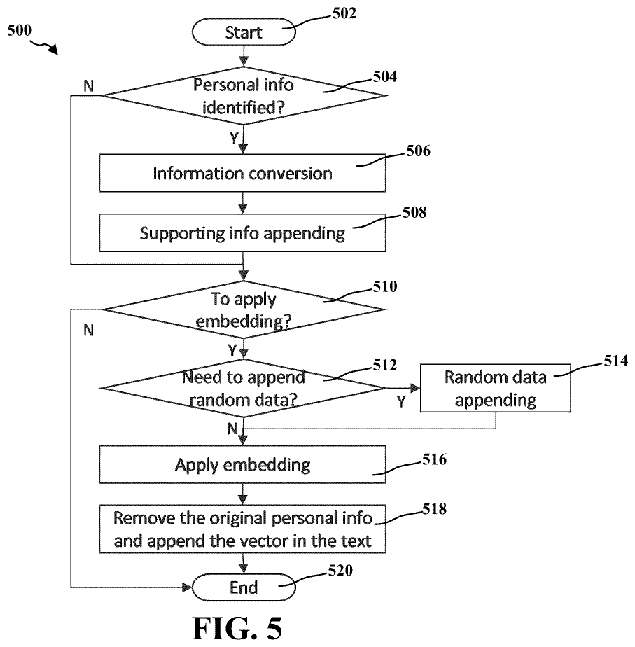

FIG. 5 is a flow chart 500 illustrating a process for implementing AI embedding and data protection. The process begins at operation 502 by receiving input text. This input text can be obtained from various sources, such as a log file generated by a computing device 300, data received through a communication connection 316, or other data streams. The input text typically includes a variety of data elements, including location information, device identifiers, timestamps, and potentially sensitive information that requires de-identification.

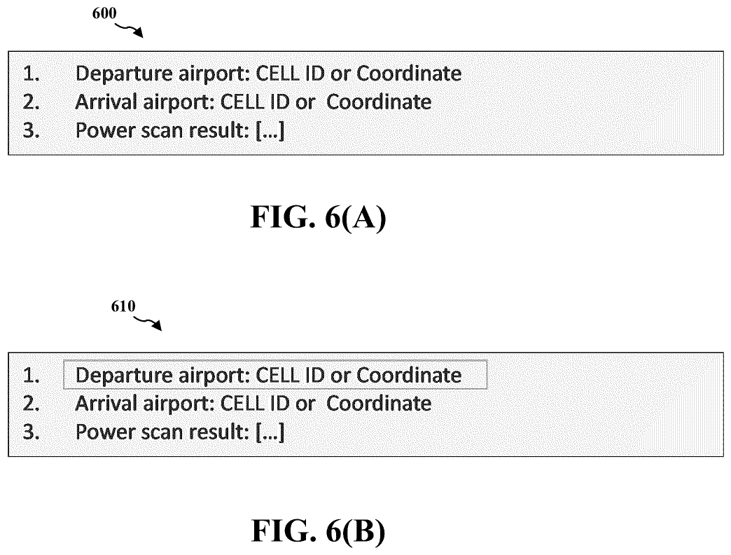

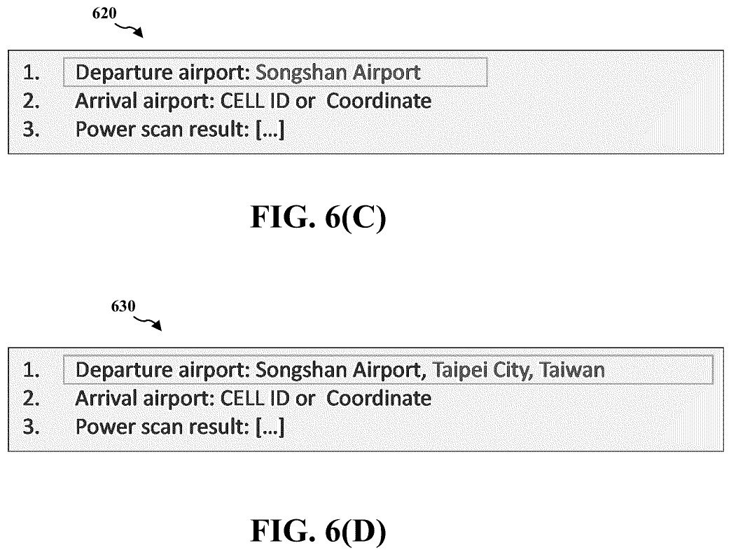

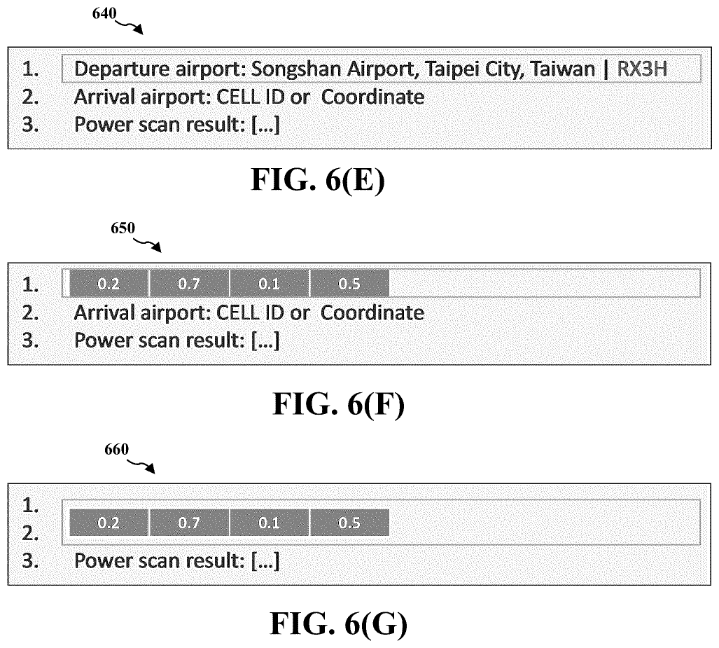

At operation 504, the system performs sensitive information identification. This step involves analyzing the input text to detect the presence of any sensitive data elements. These elements might include personally identifiable information (PII) such as names, addresses, phone numbers, account identifiers, or location data. The identification process can be based on predefined rules, pattern matching, or other techniques. If no sensitive information is detected, the process proceeds directly to operation 510, bypassing the information conversion and supporting information appending steps. This allows for efficient processing of data that does not require de-identification. However, if sensitive information is identified, the process continues to operation 506. FIG. 6(A) and 6(B) illustrate this branching logic. FIG. 6(A) is a diagram 600 illustrating an example of input text containing sensitive information such as departure and arrival airport details represented as cell IDs or coordinates. FIG. 6(B) is a diagram 610 illustrating the identified sensitive information.

Operation 506 performs information conversion. This step transforms the identified sensitive information into a semantically meaningful text representation. This conversion is important because natural language provides a richer context for similarity comparisons compared to raw numerical or symbolic data. For instance, converting a cell ID or coordinate into the name of an airport provides more semantic information for subsequent processing.

FIG. 6(C) is a diagram 620 illustrating a cell ID or coordinate is converted to “Songshan Airport.” The information conversion process supports a variety of transformations, including converting IP addresses or Wi-Fi IDs to approximate locations (city/district), mapping user app names to app categories and user interests (e.g., game/shopping), and inferring user demographics (e.g., gender, age group) from user IDs. As discussed in the Disclosure Presentation Transcript, the conversion process can also infer user behavior from temporal and location patterns, such as determining that a user departed from one airport and arrived at another based on a sequence of cell IDs and timestamps. This conversion process enables the preservation of valuable information while obfuscating the original sensitive data.

At operation 508, the system performs supporting information appending. This step enriches the converted information with additional context to improve the accuracy of similarity comparisons.

FIG. 6(D) is a diagram 630 illustrating that supporting information such as “Taipei City, Taiwan” is appended to “Songshan Airport.” This appending process can include adding hierarchical geographic details, temporal context, or other relevant information that enhances the semantic representation of the data. This additional context allows for more accurate similarity comparisons between different data points while still maintaining a level of de-identification. The appended information can be obtained from various sources, including databases, knowledge graphs, or other contextual information repositories.

Following operation 508 in the flow chart 500, at operation 510, the system determines whether to apply embedding to the text being processed. The text to be processed may be either the original input text, when no sensitive information has been identified, or the modified text resulting from the information conversion and supporting information appending operations described previously. The decision to apply embedding is generally affirmative; however, in some cases, embedding may be deferred. This deferral allows the system to collect multiple pieces of sensitive information before performing a combined embedding operation, enhancing efficiency and potentially improving the quality of the embeddings.

At operation 512, the system evaluates whether to append random data to the text before applying the embedding. Appending random data introduces a controlled amount of semantic noise, which serves to further de-identify the text while preserving its utility for similarity comparisons and analysis. The resulting embeddings are unique, even if the original texts are identical, making it more difficult for unauthorized parties to reverse-engineer the original sensitive information from the embeddings.

If the decision is to append random data, as is typically preferred for enhanced privacy, the process proceeds to operation 514, where the random data is appended to the text. FIG. 6(E) is a diagram 640 illustrating an example of random data appending. In this example, starting with the enriched text “Departure airport: Songshan Airport, Taipei City, Taiwan,” the system appends a random alphanumeric string, such as “RX3H,” resulting in the text “Departure airport: Songshan Airport, Taipei City, Taiwan|RX3H.”

At operation 516, the complete text string, including any appended random data, is input into the AI embedding model. The embedding model processes the text to generate a vector representation that captures the semantic content of the text while obfuscating the original sensitive information. The embedding operation is applied to the text segment that requires de-identification, which may be a word, phrase, sentence, or a larger text chunk, depending on the flexibility required by the application.

After embedding, at operation 518, the original sensitive text is removed from the data, and the generated embedding vector is inserted in its place. FIG. 6(F) is a diagram 650 illustrating the result of applying the embedding. The text “Departure airport: Songshan Airport, Taipei City, Taiwan|RX3H” is replaced with its corresponding embedding vector, for example, [0.2,0.7,0.1,0.5], resulting in a data structure where the sensitive information has been replaced by a numerical vector. In the case where multiple data attributes are being processed together, the system can

merge them into a single embedding vector. This alternative design approach is illustrated in FIG. 6(G), diagram 660. Instead of embedding each sensitive piece of information separately, the system combines, for example, both the departure and arrival airport information into a single text string, appends any supporting and random data, and applies the embedding to this combined text. The resulting vector, such as [0.2,0.7,0.1,0.5], encapsulates the semantic content of multiple data attributes, potentially improving the efficiency of storage and processing.

Once the embedding is complete, the process proceeds to operation 520, where it concludes. The generated embedding vectors, which have replaced the original sensitive information, can be stored securely in a vector store, such as store 424 depicted in FIG. 4, or in system memory 304 as shown in FIG. 3. These vectors are then available for further processing, including training language models, conducting data analysis, or performing similarity comparisons.

The purpose of appending random data, as implemented in operation 514, is to enhance the de-identification of the data. Since AI embedding models typically generate the same embedding vector for identical input texts, appending random data ensures that each embedding is unique. This uniqueness makes it more difficult for unauthorized parties to match embeddings to specific original texts, thereby protecting user privacy.

Moreover, random data appending introduces slight semantic variations, adding noise to the embedding process without significantly affecting the utility of the embeddings for similarity comparisons. The embeddings still preserve the overall semantic relationships between different pieces of data, allowing for effective analysis and model training, as these operations rely on comparative similarities rather than exact text reconstruction.

For example, in the test results described in the Invention Disclosure, embedding was performed on two nearly identical texts: “Departure airport: Songshan Airport, Taipei City, Taiwan” and “Departure airport: Songshan Airport, Taipei City, Taiwan|RX3H.” The resulting embedding vectors were different due to the appended random data, but their cosine similarity remained high (approximately 0.962), indicating that the semantic content was preserved. This high similarity allows the embeddings to be effectively used in AI models and analysis without exposing the original sensitive information.

By applying embedding in this manner, the system achieves a balance between data utility and privacy protection. Sensitive information is transformed into a format that is useful for machine learning and data analysis but does not expose personal details. This approach enables organizations to collect and utilize large datasets from users without incurring legal risks associated with handling personal data.

The flexibility in the embedding scope allows the system to adapt to various data types and application requirements. Whether embedding individual data attributes or combining multiple attributes into a single vector, the system can optimize the process to suit the specific needs of the analysis or model training task.

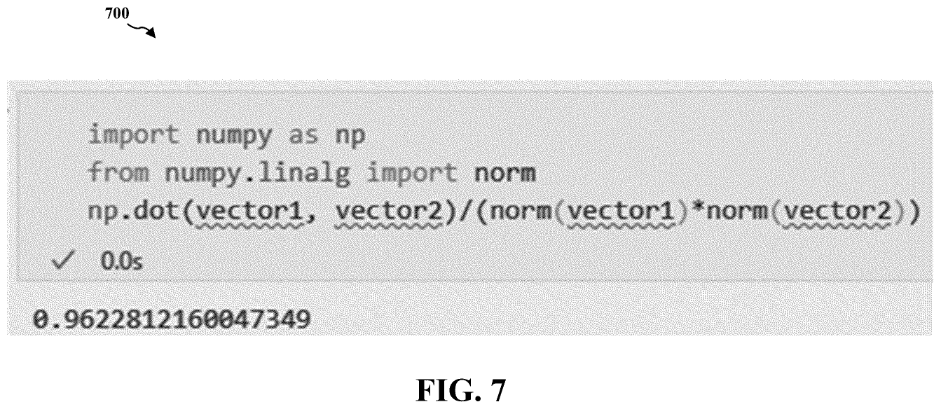

FIG. 7 is a diagram 700 illustrating code implementation and test results of the AI embedding model for validating similarity preservation after random data appending. The diagram 700 demonstrates the implementation using the numpy library in Python, a widely-used programming language for machine learning applications. The code imports numpy with the alias “np” and specifically imports the norm function from numpy.linalg module, which is essential for calculating vector normalization in cosine similarity computations.

The test compares two text strings processed through the AI embedding model described in the previous figures. The first text, “Departure airport: Songshan Airport, Taipei City, Taiwan,” represents the converted and enriched text following operations 506 and 508. The second text includes the random data appending from operation 514, reading “Departure airport: Songshan Airport, Taipei City, Taiwan|RX3H”. The AI embedding model generates distinct vector representations for each text, with the first vector beginning with 0.00021532800747081637 and the second vector starting with 0.005990174598991871.

The code implements the cosine similarity calculation. This calculation yields a similarity score of 0.9622812160047349, indicating that despite the addition of random data, the semantic similarity between the two texts remains exceptionally high (where 1.0 would indicate perfect similarity).

The results validate the effectiveness of the random data appending approach described in operation 514. While the vectors themselves are different, preserving privacy through unique embeddings, their high cosine similarity demonstrates that the semantic relationships valuable for AI model training and data analysis are maintained. This implementation supports both narrow-scope applications, such as processing data from mobile devices, and wider-scope applications including data from various devices like phones, tablets, PCs, and wearable devices.

The alternative design feature of merging multiple data attributes into a single embedding vector, as shown in FIG. 6(G), can be implemented using the same numpy-based approach. For instance, combining departure and arrival information before embedding allows for more efficient processing while maintaining the privacy-preserving properties of the system. This merged approach generates a single vector (e.g., [0.2, 0.7, 0.1, 0.5]) that encapsulates the semantic content of multiple data points, reducing storage requirements while preserving the ability to perform meaningful similarity comparisons.

The test results demonstrate that the system successfully achieves its dual objectives of de-identifying sensitive information while preserving semantic relationships necessary for data analysis and AI model development. This approach enables organizations to collect and utilize valuable user data without incurring legal risks associated with handling sensitive information, making it particularly suitable for applications in mobile devices, IoT devices, and various online services.

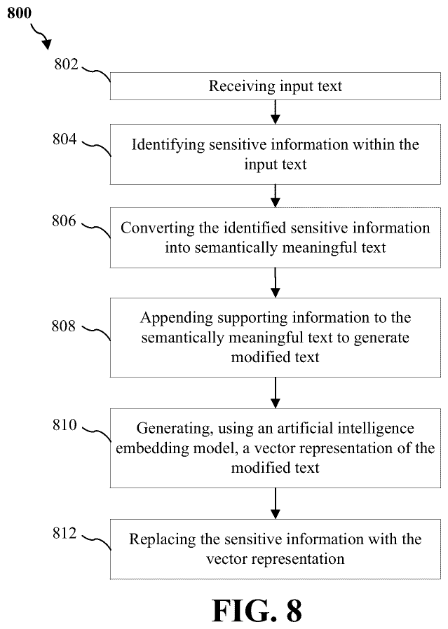

FIG. 8 illustrates a flow chart of a process for converting text into a vector. The process involves a method of operations of a computing device, such as the computing device 300.

At block 802, the computing device 300 receives input text. In some embodiments, the input text may include log data from a mobile device.

At block 804, the computing device 300 identifies sensitive information within the input text. In some embodiments, identifying sensitive information may include: analyzing the input text using pattern matching to detect personally identifiable information including at least one of: names, addresses, phone numbers, account identifiers, or location data.

At block 806, the computing device 300 converts the identified sensitive information into semantically meaningful text. In some embodiments, converting the identified sensitive information may include: converting location coordinates to a location name; and converting temporal information associated with the location coordinates to determine a type of location. Alternatively, in some embodiments, converting the identified sensitive information may include: converting a device identifier to demographic information; and converting temporal patterns of location data into behavioral indicators. Additionally, in some embodiments, converting the identified sensitive information may include: converting a sequence of cell identifiers and timestamps into travel information including departure and arrival locations.

At block 808, the computing device 300 appends supporting information to the semantically meaningful text to generate modified text. In some embodiments, appending supporting information may include: adding hierarchical geographic information to the semantically meaningful text.

At block 810, the computing device 300 generates, using an artificial intelligence embedding model, a vector representation of the modified text. In some embodiments, the artificial intelligence embedding model may be configured to generate vector representations that preserve semantic relationships while preventing reconstruction of the sensitive information. In some embodiments, generating the vector representation may include: selecting a scope of text for embedding. For example, the scope may include one of: a word, a phrase, a sentence, or a text chunk.

At block 812, the computing device 300 replaces the sensitive information with the vector representation.

In some embodiments, the method may further include: appending random data to the modified text prior to generating the vector representation. In some embodiments, the random data may include an alphanumeric string.

In some embodiments, the method may further include: identifying multiple pieces of sensitive information within the input text; combining the multiple pieces of sensitive information into a combined text string; and generating a single vector representation for the combined text string.

In some embodiments, the method may further include: storing the vector representation in a vector store; and performing similarity comparisons between the stored vector representation and other vector representations to analyze patterns in de-identified data.

In some embodiments, the method may further include: calculating a cosine similarity between: a first vector representation generated from the modified text without the random data; and a second vector representation generated from the modified text with the random data. The cosine similarity may indicate preservation of semantic relationships.

In some embodiments, the method may further include: determining whether to defer embedding of the modified text to combine it with additional sensitive information for generating a combined vector representation.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of operations of a computing device, comprising:
receiving input text;
identifying sensitive information within the input text;
converting the identified sensitive information into semantically meaningful text;
appending supporting information to the semantically meaningful text to generate modified text;
generating, using an artificial intelligence embedding model, a vector representation of the modified text; and
replacing the sensitive information with the vector representation.

2. The method of claim 1, further comprising:
appending random data to the modified text prior to generating the vector representation.

3. The method of claim 2, wherein the random data comprises an alphanumeric string.

4. The method of claim 1, wherein converting the identified sensitive information comprises:
converting location coordinates to a location name; and
converting temporal information associated with the location coordinates to determine a type of location.

5. The method of claim 1, wherein appending supporting information comprises:
adding hierarchical geographic information to the semantically meaningful text.

6. The method of claim 1, further comprising:
identifying multiple pieces of sensitive information within the input text;
combining the multiple pieces of sensitive information into a combined text string; and
generating a single vector representation for the combined text string.

7. The method of claim 1, wherein the artificial intelligence embedding model is configured to generate vector representations that preserve semantic relationships while preventing reconstruction of the sensitive information.

8. The method of claim 1, further comprising:
storing the vector representation in a vector store; and
performing similarity comparisons between the stored vector representation and other vector representations to analyze patterns in de-identified data.

9. The method of claim 1, wherein converting the identified sensitive information comprises:
converting a device identifier to demographic information; and
converting temporal patterns of location data into behavioral indicators.

10. The method of claim 1, wherein generating the vector representation comprises:
selecting a scope of text for embedding, wherein the scope comprises one of: a word, a phrase, a sentence, or a text chunk.

11. The method of claim 2, further comprising:
calculating a cosine similarity between:
a first vector representation generated from the modified text without the random data; and
a second vector representation generated from the modified text with the random data;
wherein the cosine similarity indicates preservation of semantic relationships.

12. The method of claim 1, wherein identifying sensitive information comprises:
analyzing the input text using pattern matching to detect personally identifiable information including at least one of: names, addresses, phone numbers, account identifiers, or location data.

13. The method of claim 1, wherein the input text comprises log data from a mobile device, and wherein converting the identified sensitive information comprises:
converting a sequence of cell identifiers and timestamps into travel information including departure and arrival locations.

14. The method of claim 1, further comprising:
determining whether to defer embedding of the modified text to combine it with additional sensitive information for generating a combined vector representation.

15. A computing device, comprising:
a memory; and
at least one processor coupled to the memory and configured to:
receive input text;
identify sensitive information within the input text;
convert the identified sensitive information into semantically meaningful text;
append supporting information to the semantically meaningful text to generate modified text;
generate, using an artificial intelligence embedding model, a vector representation of the modified text; and
replace the sensitive information with the vector representation.

16. The computing device of claim 15, wherein the at least one processor is further configured to append random data to the modified text prior to generating the vector representation.

17. The computing device of claim 16, wherein the random data comprises an alphanumeric string.

18. A computer-readable medium storing computer executable code for operations of a computing device, comprising code to:
receive input text;
identify sensitive information within the input text;
convert the identified sensitive information into semantically meaningful text;
append supporting information to the semantically meaningful text to generate modified text;
generate, using an artificial intelligence embedding model, a vector representation of the modified text; and
replace the sensitive information with the vector representation.

19. The computer-readable medium of claim 18, further comprising code to:
append random data to the modified text prior to generating the vector representation.

20. The computer-readable medium of claim 19, wherein the random data comprises an alphanumeric string.
